(19) United States
(12) Patent Application Publication
(10) Pub. No.: US 2020/0182750 A1
(43) Pub. Date: Jun. 11, 2020

(54) APPARATUS AND METHODS FOR FLUID TRANSPORTATION VESSELS

(71) Applicant: Pietro Fiorentini USA, Inc., Wheeling, WV (US)

(72) Inventors: Michael Yuratich, Hamble (GB); Phillip Powell, New Alresford (GB)

(21) Appl. No.: 16/609,229

(22) PCT Filed: Apr. 29, 2018
(86) PCT No.: PCT/US2018/030068

§ 371 Date: Oct. 29, 2019

Related U.S. Application Data
(60) Provisional application No. 62/492,266, filed on Apr. 30, 2017.

(51) Int. Cl. G01N 1/20; E21B 49/10; E21B 49/08

(52) U.S. Cl. CPC G01N 1/2035; E21B 49/081; E21B 49/10

(57) ABSTRACT

Methods and systems for collecting high quality reservoir samples and delivering EOR substances are disclosed. The systems and methods disclosed are especially important for collecting samples of reservoir samples in a manner that most closely resembles production fluids and maintains the samples at or above the bubble point of the fluid.

### CROSS REFERENCE TO RELATED APPLICATIONS

This application claims the benefit of U.S. Provisional Patent Application Ser. No. 62/492,266 filed 30 Apr. 2017. The disclosure of the application above is incorporated herein by reference in its entirety.

### BACKGROUND OF THE DISCLOSURE

### Field of the Disclosure

Embodiments of the present disclosure generally relate to tools and techniques for performing formation testing and, more particularly, to a novel fluid transportation apparatus and method.

### Description of the Related Art

Wireline formation testing tools are well known in the prior art in providing permeability, mobility, sampling and other information that can be inferenced therefrom about the reservoir.

In oil and gas exploration, a primary goal of a wireline testing tool is to obtain fluid samples from earth formations, representative of the reservoir. These samples are examined in special laboratories for purposes such as to discover their physical composition.

Obtaining samples is commonly achieved by the use of special tools that are run into boreholes. A snorkel in the probe of the tool can be sealed to the formation at a station of interest, and has an internal conduit to a pump. The pump is used to lower the pressure in the conduit until fluid is induced to flow from the formation. The fluid is typically initially discharged to the well bore. Monitoring devices are used to ascertain the quality of the fluid that is being pumped, until at some point the fluid is transferred to a transportation vessel or sampling receptacle (“bottle”). The bottle is sealed, then recovered to surface. At the surface the bottle typically transported directly to a laboratory for analysis. Although particularly relevant to this disclosure, some prior art includes having the sample transferred to another bottle better suited to transportation and may further include having a small amount of fluid withdrawn for immediate preliminary assessment.

The nature of well bore management is that it is filled with special fluids, commonly called ‘mud’. This fluid is a mixture of chemicals, solids and oil or water. It is designed to maintain a pressure gradient such that at any depth in the borehole, the fluid pressure exceeds that of the reservoir. This prevents collapse of the well bore, and uncontrolled production of reservoir fluids to surface. The fluid can have additional properties such as preventing chemical destabilization of the formation material.

The excess pressure of the well bore fluid over the reservoir fluid causes permeation of the former into the formation immediately surrounding the well bore. This permeation of the well bore fluids into the formation is known as invasion, and the fluid that enters the formation is known as invasion filtrate. Solid particles in the well bore fluid are unable to permeate into the formation and are left behind on the well bore surface. Over time these particles build up a thickness which itself becomes sensibly impermeable to fluid, and the invasion process ceases. The layer of particles is referred to as filter cake or mud cake.

During the pumping of formation fluids it is readily apparent to those skilled in the art that that when pumping of the fluid first commences the fluid will be invasion filtrate, followed by an increasing proportion of representative reservoir fluid. The fluid within the reservoir generally flows in streamlines. Removed from the sampling point, the flow pattern progressively changes shape, for example from omnidirectional radially converging flow (“spherical”) to flow perpendicular to the borehole but radially converging (“cylindrical”). Eventually there is a direct stream of reservoir fluid entering the sampling conduit, and the fluid boundary between invasion filtrate and reservoir fluid may, for example, be conical around the sampling point. The particular flow pattern is not significant relative to this particular disclosure and is mentioned only to reveal its existence.

When pumping, the pressure at the probe will be less than the reservoir pressure by an amount known as the drawdown. Many times prior art sampling tools fail to maintain a steady drawdown pressure and can “shock” the formation by transmitting pressure gradients into the formation. When the formation is shocked, during the sampling process, as in the case where there is an interruption to the flow, then the flow pattern rapidly changes. When flow resumes, it takes time for the pattern to return to its condition prior to the interruption. This results in a period of renewed contamination, and also a change in the reservoir state, such as the deposition of particles or fluid constituents within the pore space that may affect the representativeness of subsequently pumped fluids.

Asphaltenes are an example of a constituent present in almost all crude oils. These carbon solids have a propensity to aggregate (flocculate) and deposit from the fluid, causing irreversible changes in fluid characteristics, mobility through the formation, and, in subsequent production operations, can block pipelines and hinder refining. It is important to sample carefully without shocks to the fluid in the formation in order to obtain a representative sample, and to maintain the acquired sample above the critical pressure at which aggregation starts.

It is also important to note that in the nature of complex formation exploration tools, that failures can occur when the tools are in the borehole. Therefore, the cost of providing exploration services and the value of the formation samples are both high. A typical operational strategy might be to take a first sample as soon as contamination has been reduced significantly, to reduce exposure to failure. It is desirable to be able to take additional samples as soon as possible, but these should be high quality as the number of samples that can be taken in a single run of the formation tool in the hole is limited.

Even when representative reservoir fluid enters the sampling conduit of the formation tool, the sample can be altered or damaged by the tool itself. For example, the sour gas (such as H₂S) content of the fluid is immensely important to assessing a reservoir since it determines, among other things, the price of the crude and whether very large capital expenditures will be needed in production plant to accommodate and remove this poisonous and corroding gas. However, many commonly used materials in downhole tools readily absorb this gas. Examples include elastomers, lubricating and hydraulic oils, and certain metals. During sampling it is desirable to minimize exposure to these materials both in surface contact area and in residence time.

Another consideration in the use of formation testing tools is that almost all oil reservoirs include a significant amount of gas dissolved in the fluid. This gas may have many components. When the fluid pressure is reduced below the bubble-point pressure of any of the gas components, such as while being pumped into a formation testing tool or sample container, the gas will come out of solution. It is known to be very difficult, if not impossible, to make this gas go back into solution to restore the initial composition. Therefore, an important requirement of reservoir fluid sampling tools is to sample at pressures above the bubble point pressure, and to maintain the sampled fluid above the bubble point pressure throughout its journey from the reservoir to the laboratory. This means that pressure drops within the tool sampling conduit and within the pump, and within the sample container must be minimized. Once extracted from the formation the sample cools, and therefore shrinks in volume, during its return to the surface and can cool further during transportation depending on season and geographical transit. If the sampling receptacle has a fixed volume, shrinkage will be accompanied by a reduction in pressure, and almost always results in some gas components coming out of solution. To avoid this reduction in pressure, methods of maintaining pressure have been developed in the prior art. The methods in current practice generally entail using pressurized nitrogen bearing on the fluid sample via some sort of freely moving barrier within the sample container. The design premise behind these methods is that the nitrogen expands to fill the space left by sample fluid shrinkage, but that as a gas, its pressure does not drop dramatically with temperature, and its pressure remains above the sample bubble point pressure. In this way the nitrogen acts as a spring and urges the freely moving barrier against the sample to maintain pressure above the bubble point.

Another consideration in the use of formation tools is the consequence of prolonged residence time within the tool between the time the reservoir fluid enters the sampling conduit and the time when the reservoir fluid enters the sampling receptacle. If the time is too long, the components of the sample can separate. The residence time can be prolonged by the nature of the tool design or by the reservoir characteristics. In the latter case, a low permeability formation may only permit a low sampling flow rate, as a higher rate would drop the sampling pressure to below the fluid bubble point. A low sampling rate necessarily results in a longer residence time. It is desirable therefore to minimize the physical volume of the conduit and, in most prior art formation tools, the pump displacement, to reduce the separation of the sample components. Filling a receptacle with a fluid of stratified components will result in a mixture that is unrepresentative of the formation. Moreover the component fractions may differ from the original fluid due to different transit times and traps within the tool.

A further consequence of a complex fluid path between the formation and the receptacle is that contamination can occur from residues of samples taken earlier in the process, including from a previous station.

There are several patents in the prior art directed at sample receptacles that attempt to maintain samples at reservoir conditions. One such patent is U.S. Pat. No. 6,688,390 which comprises a cylinder having two pistons separating the bottle into three chambers. Samples are run through the main pump and injected into one end of the bottle. A middle chamber is filled with a buffer fluid and a chamber on the other end of the bottle contains a gas. The pressure of the gas is regulated to exert pressure onto the buffer fluid and in turn onto the sample. Other such patents include U.S. Pat. Nos. 7,246,664 and 7,191,672 both of which disclose a bottle which comprises a cylinder having two pistons separating the bottle into three chambers. In a similar manner sample fluids are run through the main pump and injected into one end of the bottle. The middle chamber is filled with a gas fluid and the other end of the bottle is filled with wellbore fluid. Both latter patents disclose a method of filling the middle chamber through a valve located in one of the pistons. In prior art embodiments where samples are run through the main pump prior to injection into the sample bottle, poor sampling can result because the pump “chews” up the fluid passing therethrough. In addition, the sample fluid experiences a pressure drop in the intake valves of the pump that can be sufficiently large enough to flash any condensates present in the sample liquid.

In addition to fluid receptacles carried downhole for sample collection, it is known in the art to carry fluid receptacles filled with completion, or enhanced oil recovery (EOR) substances downhole. As used herein, the term testing fluids will refer to both reservoir samples and EOR fluids. These EOR fluids are injected from the fluid receptacles into the formation to determine their efficacy in increases the production of the well. An exemplary prior art patent that discloses a fluid transport system for collecting downhole fluids and carrying them to the surface as well as carrying completions fluids from the surface to a downhole location is set forth in U.S. Pat. No. 8,418,546.

It is therefore an object of the present disclosure to have a method and apparatus for obtaining formation fluid samples that will minimize operation time, reduce the complexity and volume of those parts of the tool in contact with the fluid prior to the fluid container, not disturb the formation throughout the sample taking at a given station and will maintain the fluid above its bubble and asphaltene points throughout its journey from reservoir to laboratory. Another object of the present disclosure is to provide for apparatus and methods for carrying fluid receptacles filled with completion, or enhanced oil recovery (EOR) substances from the surface to downhole locations. It is a further objective to maximize reliability and minimize cost by implementing a novel fluid container.

### SUMMARY OF THE DISCLOSURE

In some aspects of the present disclosure, a novel apparatus for carrying testing fluids is presented wherein the tool comprises a housing having at least two pistons slidably disposed therein and dividing the housing into at least three chambers, each of the at least three chambers having a variable volume, including an intermediate chamber, a first end chamber and a second end chamber, the intermediate chamber defined by the pistons and wherein the pistons are free of valves and a first conduit for pressurizing the intermediate chamber with a gas, a second conduit adapted to transfer the testing fluid into and out of the first end chamber, and a third conduit adapted to transfer a buffer fluid into and out of the second end chamber.

In other aspects of the present disclosure, the transfer of the buffer fluid into the second end chamber reduces the volume of the intermediate chamber, transfer of the buffer fluid out of the second end chamber causes the transfer of the testing fluid into the first end chamber and the transfer of the buffer fluid into the second end chamber causes the transfer of the testing fluid out of the first end chamber.

In still other aspects of the present disclosure, a tension member having a length less than an axial length of the housing is coupled to the at least two pistons and the tension member can be a limit bar where the at least two pistons are slidably positioned on the limit bar and the limit bar further has a shoulder positioned on each end thereof to limit an axial travel of the at least two pistons.

In yet other aspects of the present disclosure there is a main pump for extracting a formation fluid from a formation and connected to a flow line having an inlet in fluid communication with the formation and the apparatus for carrying testing fluids is positioned between the main pump and the inlet and a secondary pump to selectively transfer the buffer fluid into and out of the second end chamber.

In some aspects of the present disclosure, a novel method for carrying testing fluids is presented wherein a housing is divided into at least three chambers, each of the at least three chambers having a variable volume, including an intermediate chamber, a first end chamber and a second end chamber, the intermediate chamber is pressurized with a gas, a testing fluid is transferred into and out of the first end chamber and a buffer fluid is transferred into and out of the second end chamber.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates a high level schematic representation of the use of a formation tester, including a fluid transportation module in accordance with certain aspects of the present disclosure.

FIG. 2 illustrates a formation tester, including a fluid transportation module of a fluid transfer system in accordance with certain aspects of the present disclosure.

FIG. 3 is a schematic representation of a fluid receptacle in accordance with certain aspects of the present disclosure.

FIG. 4 is a schematic representation of a fluid receptacle in accordance with certain aspects of the present disclosure.

FIG. 5 is a schematic representation of a fluid receptacle in accordance with certain aspects of the present disclosure.

FIG. 6 is a schematic representation of a fluid receptacle in accordance with certain aspects of the present disclosure.

FIG. 7 is a schematic representation of a fluid receptacle in accordance with certain aspects of the present disclosure.

FIG. 8 is a hydraulic diagram of a fluid transportation system for obtaining samples of downhole formation fluids in accordance with certain aspects of the present disclosure.

FIG. 9 is a hydraulic diagram of a fluid transportation system for obtaining samples of downhole formation fluids in accordance with certain aspects of the present disclosure.

FIG. 10 is a hydraulic diagram of a fluid transportation system for obtaining samples of downhole formation fluids in accordance with certain aspects of the present disclosure.

FIG. 11 is a section view of an exemplary fluid receptacle in accordance with certain aspects of the present disclosure.

FIG. 12a is a section view of an embodiment of a testing fluid vessel and pressurizing tool in accordance with certain aspects of the present disclosure.

FIG. 12b is a section view of an embodiment of a testing fluid vessel and pressurizing tool in accordance with certain aspects of the present disclosure.

FIG. 13 is a section view of an embodiment of a testing fluid vessel and pressurizing tool in accordance with certain aspects of the present disclosure.

### DETAILED DESCRIPTION

The present disclosure is a formation dynamic testing (FDT) tool which can include a probe and fluid transportation system for collecting high quality reservoir samples and injecting EOR fluids. The fluid transportation system includes fluid receptacles positioned in close proximity to the probe. The present disclosure can comprise a wireline deployed formation tester or a logging while drilling (LWD) or measurement while drilling (MWD) tool having the ability to dynamically flow fluids from the reservoir while producing information about the reservoir fluids and their production.

### Examples of Tools for Collecting High Quality Reservoir Samples

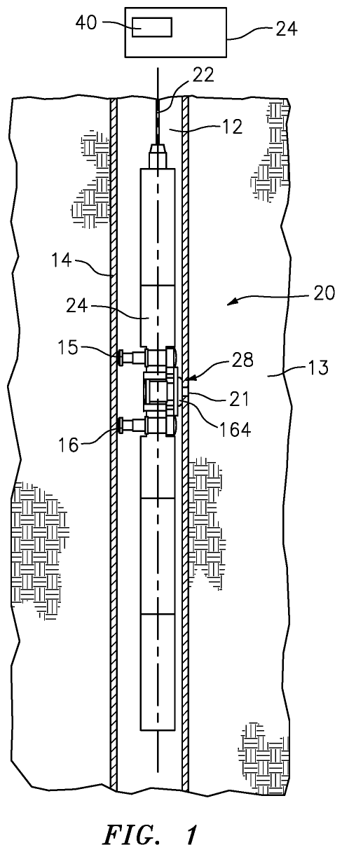

With reference to FIG. 1 there is shown an embodiment of a formation testing tool 20 deployed within a well 12 drilled into formation 13. In operation, the formation testing tool 20 is deployed into well 12 via wireline 22. As is well known in the art, wireline 22 includes electrical conductors for powering the tool, data communications conductors as well as tensile members for supporting the weight of the testing tool. The borehole typically contains various mixtures of fluids and gasses wherein the mixture varies by depth, age of the well and various other factors. The well is shown as an open hole however, the present disclosure is not limited to open hole wells and could, for instance, be used within a cased hole well.

FIG. 1 illustrates an embodiment of the formation testing tool 20 wherein the tool is shown deployed in well 12 and includes various modules as will be described in more detail herein below. The wireline cable 22 can comprise a multi-conductor cable that carries electrical power and data to and from processing unit 24 located at the surface. The power and processing unit includes the capability to control the various modules included in the formation testing tool 20. In addition, power and processing unit 24 includes a processor 40, in the form of a computer and the like, for processing the electrical signals from the tool into information concerning the analysis and characterization of the downhole fluids. In this particular embodiment, the formation testing tool 20 includes a clamping mechanism comprised of pistons 15, 16 that is urged against the borehole wall by the pistons to stabilize the formation tester within the wellbore 12. The formation tester includes a probe assembly 28 having a mechanism to urge the probe pad 164 against borehole wall with sufficient force to releasably fix the formation tester in place. The probe pad further seals the formation 13 from the wellbore 12 in the area of contact. The snorkel 21 of probe assembly 28 contacts and can penetrate borehole wall 14 and any mud cake that may exist adjacent thereto and comes into fluid communication with the formation 13. As will be described in greater detail herein below, the snorkel 21 is in hydraulic communication with a pump mounted within the formation tester housing 26. The probe assembly 28 may also include a guard ring (not shown) and which may comprise a loop that encircles the ring and is hydraulically coupled to a pump mounted within the formation tester housing 26. An exemplary embodiment of a focused guard probe is disclosed in U.S. Pat. No. 6,301,959 (959) to Hrametz, the disclosure of which is included herein in its entirety.

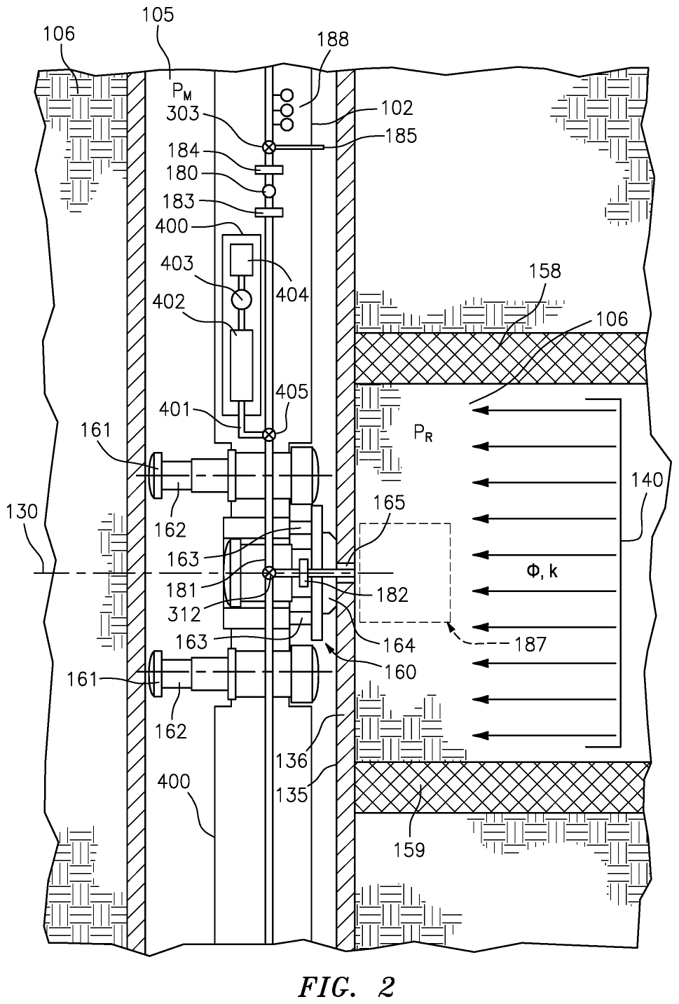

With reference to FIG. 2, there is shown an embodiment of a formation testing tool 102 of the present disclosure deployed within a well 105 drilled through a layer of formation 106 having a porosity Φ and a permeability k. The well is shown as an open hole however, the embodiments of the present disclosure are not limited to open hole wells and could, for instance, be used within a cased hole well with proper additions made thereto to penetrate the casing. In this particular embodiment, the formation testing tool 102 includes a clamping mechanism, or shoes, 161 that are urged against the borehole wall 135 by pistons 162 with shoes 161, that together with the probe assembly, stabilize the formation tester within the wellbore 105. The formation tester includes a probe assembly 160 having a pair of pistons 163 to urge the probe pad (or doughnut packer) 164 against borehole wall 135 with sufficient force to releasably fix the formation tester in place. The probe and the pistons cooperate together so that the formation tool does not rotate or wobble in the preselected downhole position. The probe pad 164 further seals the formation 106 from the wellbore 105 in the area of contact with borehole wall 135. The snorkel 165 contacts the borehole wall 135 and any mudcake that may exist adjacent thereto and enters into fluid communication with the formation 106. The snorkel 165 is in hydraulic communication with main pump 180 mounted within the formation tester housing 107. The probe assembly 160 may also include a guard ring (not shown) as which may comprise a loop that encircles the ring and is hydraulically coupled to main pump 180 mounted within the formation tester housing 107. Although the present disclosure is described with reference to an embodiment having a donut packer and probe, it is within the present disclosure to include any type of sampling tool including straddle packer tools. For instance, sampling can take place in an open hole from between packers of straddle packers, i.e. without a probe. In such circumstances the flow paths are often more cylindrical, particularly if the top packer is set under an impermeable layer in the formation. In examples where the wellbore is cased, the straddle packers are located over perforations in the casing for obtaining samples.

It is known in the art to provide a wellbore fluid (not shown to avoid confusion), sometimes referred to as a mud, within the wellbore to produce a mud pressure P_{M} greater than the reservoir pressure P_{R} to create an overbalanced condition and prevent formation fluid 140 from entering the wellbore. As described herein above, because P_{M} is greater than P_{R} some of the mud enters the formation creating both a mud cake (solids from the mud) on the borehole wall 135 and a zone of formation fluid that is contaminated with the filtrate (fluid from the mud), also known as invaded zone 136, in the formation 106 adjacent to the borehole wall.

In operation, the formation testing tool 102 is lowered by wireline (22 in FIG. 1) to a nominal predetermined depth 130. As is known in the art, the shoes 161 and probe assembly 160 are urged against the borehole wall 135, and the snorkel 165 contacts borehole wall 135 and can penetrate into invaded zone 136 and the formation 106. A small pretest module 182 draws a sample to confirm the seal is made and determines the initial reservoir pressure P_{R} and permeability using well-known techniques. With valves 312, 405 and 303 appropriately positioned, main pump 180 draws fluid through the snorkel 165, into flowline 181, and circulates at least some of the fluid back into the wellbore 105 via flow line 185. Fluid is pumped through snorkel 165 for a sufficient period of time to remove most, if not all, of the invaded fluid in the testing volume 187 near the snorkel 165 to obtain filtrate free formation fluid 140. Using well-known techniques, testing module 183 provides real time data to operators to assist in determining when the formation tester is producing filtrate free formation fluid 140. Such testing modules may include, pressure sensors, optical analyzers, density analyzers, NMR, Sigma Neutron as disclosed in co-pending application WO2017015340, the disclosure of which is incorporated herein in its entirety, and other such known testing modules. In prior art sampling devices, the sample receptacles are placed downstream of main pump 180, and due to the effects on the fluid of passing through the pump, an additional testing module (not shown) is typically required to verify the sample quality after exiting the pump and prior to entering the sample receptacle. The second testing module adds expense and complexity to the prior art tools. Once the formation fluids 140 are being produced in a single phase and free of invaded fluid from the testing volume 187 of the formation 106 they are ready to be sampled.

Still referring to FIG. 2, embodiments of the present disclosure include a fluid transportation module 400 which includes fluid transport line 401, fluid receptacle (or bottle) 402, secondary pump 403, and buffer fluid chamber 404. In accordance with the present disclosure, it is advantageous to position the fluid transportation module 400 as close to the snorkel 165 as possible. With the fluid transportation module 400 and the fluid receptacle 402 positioned close to the snorkel 165 many of the prior art problems are eliminated including minimizing the time that the sample is in flowline 181 and elsewhere, including fluid transport line 401, to reduce stratification and reaction of the formation fluid 140 with the flow lines and minimizing pressure drops caused by long flow lines. In certain embodiments buffer fluid chamber 404 can be exposed to the pressure of P_{M} to facilitate the operation of fluid receptacle 402. It should be noted that, as part of this disclosure, wellbore fluid is not considered a buffer fluid. It should be noted that although the fluid receptacle is shown as positioned between main pump 180 and snorkel 165, the fluid receptacle can be placed any various locations and filled using various methods a are known in the prior art.

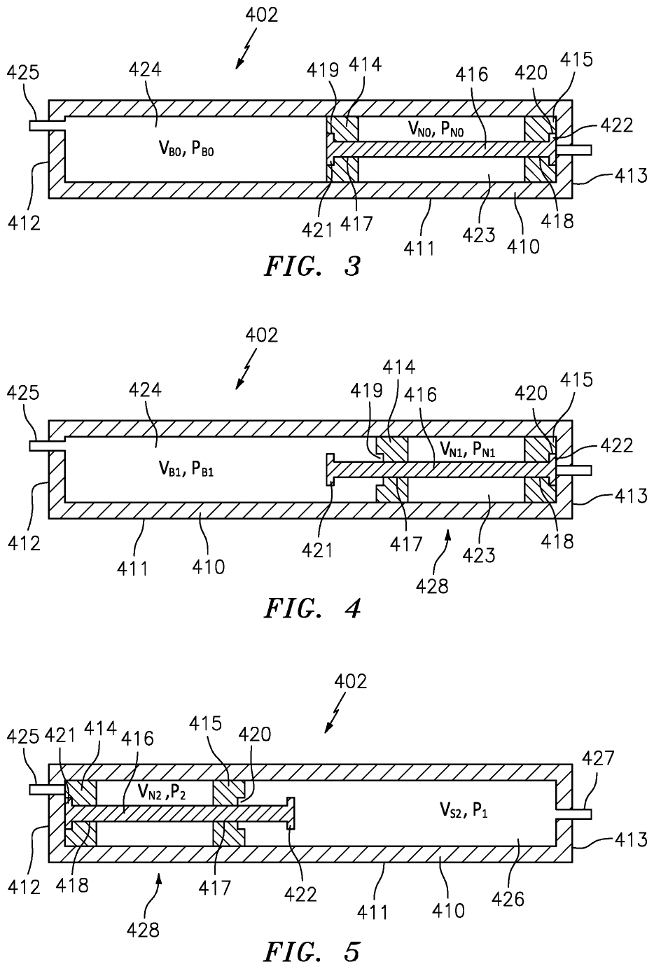

Referring to FIGS. 3-7, an embodiment of the present disclosure fluid receptacle 402 will be described in greater detail with respect to sampling formation fluids 140 (FIG. 2). The nomenclature and relationships in the following Table 1 are useful in interpreting the operational steps and methods associated with the present disclosure as will be more fully disclosed herein after.

TABLE 1

| | Volumes | | | Pressures | | |
|---|---|---|---|---|---|---|
| Step | Buffer | Nitrogen | Sample | Buffer | Nitrogen | Sample |
| 0 Preparation | V_{B0}, bal. | V_{N0} | 0 | 0 | P_{N0} | 0 |

| | | | | |
|---|---|---|---|---|
| 1 Prefill | V_{B1}, bal. | V_{N1} | 0 | P₁ = P_{R} − P_{drawdown} |
| 2 Filled | 0 | V_{N2} = V_{N1} | V_{S2}, bal. | P₂ = P₁ |
| 3 Pressurize | V_{B3}, bal. | V_{N3} | V_{S3} | P₃ = P₁ + ΔP |
| 4 Surface | V_{B4}, bal. | V_{N4} | V_{S4} | P₄ |

In Table 1, because the total volume of the fluid receptacle 402 is fixed, the notation “bal.” is that volume remaining in the receptacle after subtracting the volume of the other two fluid components. It will be readily understood by one practiced in the art that piston seal friction requires a small pressure difference to overcome the friction, but it may be ignored herein without departing from the scope of the disclosure. Similarly, zero pressure is an approximation to atmospheric pressure. Now, with reference to Table 1 and to FIG. 3, there is shown an embodiment of fluid receptacle 402 after initially being prepared at the surface at Step 0. Fluid receptacle 402 includes a hollow housing 410, which in certain embodiments is cylindrical in shape, and includes a wall 411 and end walls 412, 413 wherein the end caps define an axial length of the housing therebetween. Positioned within housing 410 are a pair of pistons 414, 415 arranged to seal against the inner surface of wall 411 and are further permitted to slide in the axial direction of housing 410. Pistons 414, 415 are free of valves but include holes 417, 418, respectably, which accommodate limit bar 416 in a slidable sealing arrangement therein and in this particular embodiment further include shoulder slots 419, 420 which cooperate with shoulders 421, 422 of the limit bar to limit the maximum axial travel of the pistons to the length of the limit bar as will be more fully described herein below. It should be appreciated that pistons 414, 415 divide fluid receptacle 402 into three variable volume chambers: a first end chamber, an intermediate chamber and a second end chamber. With pistons 414, 415 positioned as shown, pressure chamber 423, having an initial volume of V_{N0}, is formed therebetween. Pressure chamber 423 is filled at the surface with nitrogen, or other suitable compressible composition, as will be more fully described herein below, to a predetermined gas pressure P_{N0} and pistons 414, 415 are urged apart by the pressure and against shoulders 421, 422. The nitrogen in pressure chamber 423 provides a compressible cushion against which the pressures of the sample and a buffer fluid are maintained as will be fully described herein below. Buffer fluid chamber 424 is then filled with a suitable buffer fluid, chosen from a group of nearly incompressible fluids such as mineral oil, and piston 415 is urged against end wall 413 as shown in the figure. Buffer fluid chamber 424 is thus formed between piston 414 and end wall 412 and has a starting buffer fluid volume of V_{B0} and, because the pressure at the surface is atmospheric, buffer fluid pressure P_{B0}=0. In the embodiment shown, P_{N0} can be less than the pressure of the buffer fluid P_{B} and with piston 415 against end wall 413 there exists minimal “dead volume” in the sample receptacle. It is important to note that the fluid receptacle 402, as well as all of its components, should be comprised of materials and design sufficient to withstand the downhole temperatures, pressures and chemicals encountered in such an operation, and the corresponding conditions at all stages of its subsequent handling and transport when filled. Although the embodiment is shown as a rigid structure, the present disclosure includes any embodiment having a constant volume and multiple chambers therein divided by moveable barriers such as membranes.

Now referring to FIG. 4, there is shown the fluid receptacle 402 of FIG. 3 at Step 1, of Table 1, when the receptacle is positioned within fluid transport module (400 of FIG. 2) while the formation testing tool 102 is lowered to a predetermined depth 130 in the borehole by wireline (22 in FIG. 1). As described herein before, the borehole is filled with wellbore fluid or mud, to produce a mud pressure P_{M} greater than the reservoir pressure P_{R}, wherein P_{R} is normally determined by the aforementioned drawdown pressure test, and wherein it is well known that P_{M} increases with depth. In some embodiments, buffer orifice 425 is adapted to transfer buffer fluid in and out of chamber 424 may be open to the borehole wherein P_{B} is equal to P_{M}. In other embodiments, secondary pump 403 of FIG. 2 is configured and controlled to provide buffer fluid from buffer fluid chamber 404 to chamber 424 through buffer orifice 425 at a pressure P_{B1} approximately equal to, or greater than, P_{M}. It is important to note that when buffer fluid chamber 404 is exposed to pressure P_{M}, as when being lowered down hole, it does not comingle with wellbore fluid, secondary pump 403 can be bypassed with a valve (not shown) or only has to selectively transfer an additional pressure slightly greater than P_{M} to position the piston limit bar assembly 428 (comprised of pistons 414, 415 and limit bar 416) as shown in FIG. 4. Because of the increase in P_{B}, the nitrogen pressure is similarly increased to P_{N1} and piston 414 is urged off shoulder 421 and traverses axially along limit bar 416. Piston 415 maintains contact with end wall 413 and the volume V_{N1} of pressure chamber 423 is proportionally reduced in accordance with well-known principles.

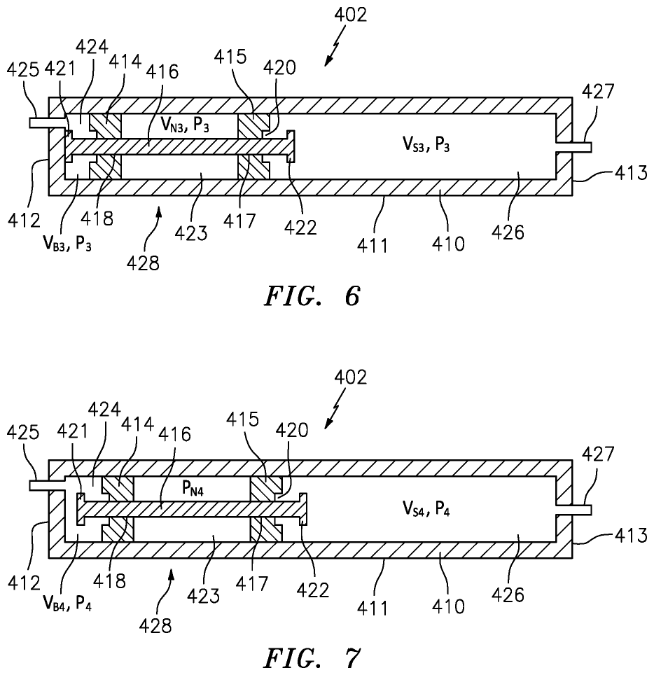

With specific reference to FIG. 5, and general reference to FIG. 2, at Step 2 of Table 1, fluid receptacle 402 is shown after sample chamber 426 is filled with a sample of formation fluid 140. As should be understood by those skilled in the art, conduit or port 427 in end wall 413 can be fitted with a valve (not shown) is adapted to transfer testing fluids in and out of chamber 426, which valve can comprise a self-actuating check valve, a motorized or hydraulically actuated valve or the like, opened to snorkel 165, to allow the entry of formation fluid 140. In order for formation fluid 140 to enter fluid receptacle 402, main pump 180 and secondary pump 403 are cooperatively controlled in such a manner that the flow through snorkel 165 maintains a constant pressure at the probe near P₁ so as not to shock the formation. In so controlling the pumps 180, 403, secondary pump 403 withdraws buffer fluid from chamber 424 through buffer orifice 425 reducing the pressure in pressure chamber 423 below P_{N1}, and as the nitrogen pressure approaches P₁, piston 415 moves off of end wall 413. Because the overall internal volume of fluid receptacle 402 is constant, as piston 415 moves away from end wall 413 the volume V_{B} of buffer fluid chamber 424 decreases and the volume V_{S} of sample chamber 426 increases. Formation fluid 140 is drawn into sample chamber 426 though port 427 and exerts a pressure nearly equal to P₁ against piston 415. As secondary pump 403 continues to draw buffer fluid out of buffer fluid chamber 424 the syringe-like action produces a negative displace condition and causes piston limit bar assembly 428 to move axially inside of housing 410 until piston 414 is urged against end wall 412 wherein the volume of buffer fluid chamber 424 becomes 0, pressure chamber 423 is at V_{N1}, P₁ and the formation fluid volume of sample chamber 426 is at V_{S2}, P₁. In the case where limit bar 416 touches end wall 412 first, the pistons 414, 415 will continue to slide on the limit bar until piston 414 is urged against end wall 412. It should be appreciated by those skilled in the art that the volume of buffer fluid in chamber 424 is displaced by the sample of formation fluid 140 that is drawn into sample chamber 426. Once sample chamber 426 is filled, port 427 is closed off by any known method, including the aforementioned valve, and secondary pump 403 is gradually stopped while main pump 180 is increased to maintain a constant pressure at the snorkel 165. With this unchanged flow rate at the probe, the formation intake pressure and reservoir fluid equilibrium is undisturbed. In addition, the negative, or non-positive, displacement, with respect to sample chamber 426, caused by the sucking action of the buffer fluid by secondary pump 403 allows the sample formation fluid 140 to be drawn into the sample chamber 426 without having to go through a pump as in the prior art. This is an important aspect of the present disclosure in that the sample fluid arrives within the sample chamber 426 with minimal changes from the condition it was in within the reservoir, i.e. it is more representative of the reservoir fluid than samples provided by sampling tools of the prior art.

As described herein before, it is an important aspect of the present disclosure to constantly maintain P_{S} above the predicted bubble point of the reservoir fluid where the sample was taken. Referring to FIG. 6, and in accordance with the present disclosure, an over pressure procedure, Step 3 of Table 1, is undertaken whereby buffer fluid is added through buffer orifice 425 by secondary pump 403 into buffer fluid chamber 424 in a sufficient quantity and pressure to reduce the volume of pressure chamber 423 to V_{N3} and increase the pressure thereby to over pressure P₃. Because the sample of formation fluid 140 in sample chamber 426 may be compressible due to dissolved gas in the fluid, the formation fluid volume of the sample chamber after over pressure V_{S3} may be somewhat smaller than when the sample was at P₁. Also, since the buffer fluid is also chosen from a group of nearly incompressible fluids, piston 414 is urged off shoulder 421 during the over pressure procedure creating volume V_{B3} in buffer fluid chamber 424. As the pressure increases to over pressure P₃, piston 415 will pressurize the sample and can also travel in the direction of the sample until pressures in buffer fluid chamber 424, pressure chamber 423 and sample chamber 426 are in balance. The volume of the pressure chamber 423 reduces as the pressure increases. The final over pressure P₃ of sample, nitrogen and buffer fluid (ignoring seal frictions as herein above mentioned) exceeds P₁ and is chosen to provide sufficient pressure P_{S} within sample chamber 426 when the sample is brought to the surface to maintain P_{S} above the bubble point. Where possible, the embodiment design and pressures are such that P_{S} will always be above P₁. P₁ is known to be above bubble point since it is the sampling pressure, and the fluid at this pressure is carefully monitored for gas-breakout during pumping as herein before described.

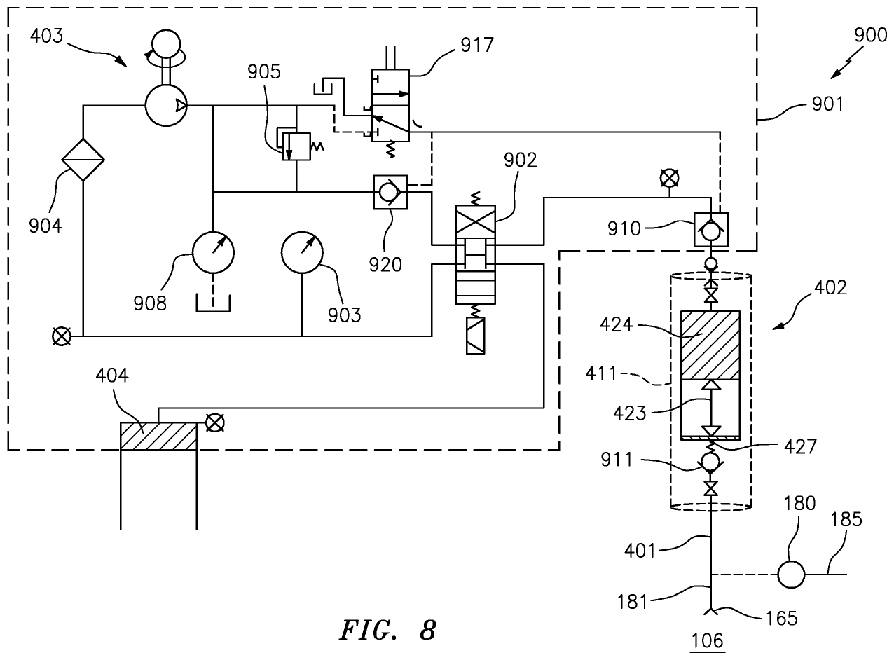

Referring to FIG. 7, and in accordance with the present disclosure, Step 4 of Table 1 can be accomplished upon completion of the sample filling of Step 2 and over pressure procedures of Step 3 described directly herein above, wherein formation testing tool 102 can be raised back to the surface by a wireline (22 in FIG. 1). As will be understood by those skilled in the art, when the fluid receptacle(s) 402 are raised to the surface, the ambient temperature and pressure conditions are lower than existed at the predetermined depth 130. The temperature difference between the surface elevation and the testing elevation can exceed several hundred degrees Fahrenheit. As formation testing tool 102 is retrieved, the sample chamber 426 temperature drops, causing the sample volume V_{S}, and to a lesser extent the buffer fluid volume V_{B}, to reduce by well-known principles and so causing the pressure in sample chamber 426 P_{S} to drop. If allowed to go unchecked, as in many sample containers of the prior art, this substantial pressure drop in the sample chamber can result in P_{S} dropping below the bubble point, resulting in a multi-phase sample. It is also important that P_{S} not drop below the asphaltenes point or even the point of asphaltenes precipitation. In accordance with the present disclosure, the ambient pressure at the surface has no effect on the chambers 423, 424, 426 because the housing is sealed from the atmosphere. Because the temperature at the surface position is lower than downhole, and the volume of buffer fluid chamber 424 and sample chamber 426 are reduced to V_{B4} and V_{S4} respectively, the volume of pressure chamber 423 will increased proportionally to V_{N4} and its pressure P_{N4} will be less than P₃. It should be appreciated by those skilled in the art that the combination of the preselected P_{N0} and over pressure P₃ ensure that P₄ is maintained in sample chamber 426, and the sample formation fluid 140 therein, above the bubble point pressure at all times during the sampling, retrieval and transporting processes.

It is a further aspect of the present disclosure that a pressure gauge (not shown) may be added to buffer orifice 425 to directly monitor the pressure of the buffer fluid or port 427 to monitor the pressure of the sample directly thereby as will be more fully explained herein below. It should be recognized by one skilled in the art that such an arrangement is advantageous in logging the pressure of the sample during transportation and maintaining the chain of custody of the sample. Such a pressure gauge may be any suitable type such as a MEMS pressure gauge.

It should also be appreciated by those skilled in the art that although embodiments of the present disclosure are shown with a limit bar as a tension member between the piston pair, any suitable tension member such as a chain, cable, carbon fiber and the like may be substituted without departing from the scope of the present disclosure.

It should further be appreciated by those skilled in the art that fluid receptacle 402 of the present disclosure delivers a more representative sample of the formation fluid than that of the prior art and includes many advantages over the prior art such as the sample fluid does not pass through a pump. The fact that the formation fluid does pass through a pump prior to entering the fluid receptacle 402 means that there is no scavenging of H₂S, no pressure disturbances caused by valves in which gas can break out, no residence time in pump cylinders that permits segregation (leading to the taking of samples unrepresentative of the formation), no contamination with residual fluids taken at other stations, and that only one set of monitoring equipment is required. The fact that the sample chamber may be filled using a negative displacement method leads to the sample being taken at sensibly constant sampling pressure further ensuring the consistency of sample quality and its representativeness of the fluid in the reservoir.

Many tools of the prior art use a main pump 180 of positive displacement piston type. The pistons reciprocate and at their change of direction short periods of flow interruption occur. Embodiments of the present disclosure can improve upon this by using the secondary pump 403 to maintain constant flow during sampling. Where this arrangement could be insufficient it is also possible to select the displacement volume of the main pump 180 to be greater than the sample volume V_{S3} and coordinate the timing of the piston strokes so that the sample is taken within one stroke of secondary pump 403. Alternatively, main pump 180 can be of a progressive cavity type, which is valveless and non-reciprocating, resulting in a continuous smooth flow. Progressive cavity pumps have a low pressure head rating relative to their length, so their use is practically limited to lower drawdown-pressure applications, of which sampling from a straddle packer is one. A further alternative pump type may be a multi-piston swash-plate type, which maintains a more continuous flow considering the overlapping action of the pistons eliminates interruptions in the flow. This is practically limited to smaller pumps and can be an alternative type for secondary pump 403.

Referring now to FIG. 8, there is shown a hydraulic circuit 900 associated with an embodiment of the present disclosure. FIG. 8 illustrates fluid receptacle 402 during the initial preparation stage, at Step 0 of Table 1, and corresponding FIG. 3, where like numerals indicate like components. Hydraulic circuit 900 includes buffer fluid control circuit 901, which comprises buffer fluid chamber 404, isolation valve 902, pressure gauge 903, filter 904, secondary pump 403, electronically controlled isolation valve 917 and a second pressure gauge 908. It should be noted that one skilled in the art could add other minor components such as over-pressure relief valves as appropriate to protect the circuit without departing from the scope of this disclosure. Buffer fluid control circuit 901 further includes means for actuating piloted check valve 910, shown as closed in this figure, to control fluid communication between buffer fluid chamber 424 and buffer fluid chamber 404 as will explained more fully herein below. Also shown in the figure is check valve 911, shown in the closed position, disposed between port 427 and snorkel 165 to control reservoir fluid communication there between. In this embodiment, isolation valve 902 is closed, as well as piloted check valves 910 and 911, and pressure chamber 423 is at V_{N0}, P_{N0}, which maintains the closed volume of fluid receptacle 402 at a balanced condition from the initial preparation stage at the surface as it is lowered into the well to a predetermined depth 130 to prefill Step 1, just prior to filling the sample chamber.

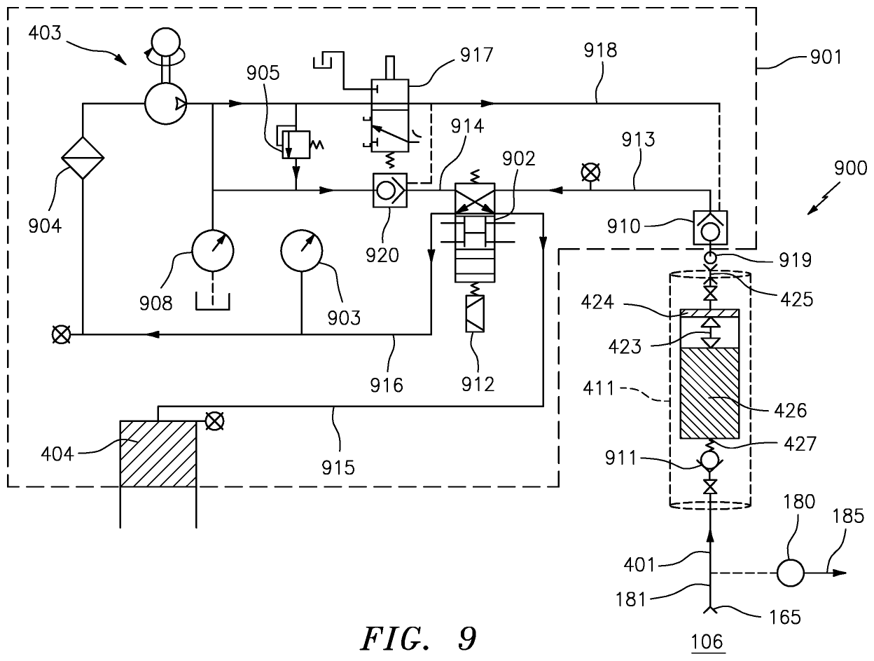

FIG. 9 shows hydraulic circuit 900 during Step 2 of the filling of the sample chamber 426. During sample filling operations, actuator 912 of buffer fluid control circuit 901 positions servo valve 902 as shown to establish fluid communication between flow line 913 and flow line 916 and to further establish fluid communication between flow line 914 and flow line 915. Isolation valve 917 is energized and secondary pump 403 pumps buffer fluid through flow line 918 to open piloted check valve 910 and piloted check valve 920 as shown. Buffer orifice 425 is connected to check valve 919 which check valve is shown in the figure as open. As described herein above, secondary pump 403 is controlled in conjunction with main pump 180 to maintain the reservoir at P₁ so as to not shock the reservoir. As buffer fluid is pumped from buffer fluid chamber 424 it travels into flow line 913 and makes its way through hydraulic circuit 900 and into buffer fluid chamber 404 as shown by the directional arrows in the figure. As described herein above with reference to FIG. 5, as the buffer fluid is withdrawn from buffer fluid chamber 424 there is a negative displacement created within fluid receptacle 402, creating sample chamber 426, which draws reservoir fluid from snorkel 165 and flowline 181 into the sample chamber through fluid transport line 401, check valve 911 and port 427 until the sample chamber volume is full at V_{S2}. When sample chamber 426 is full, the gas volume of pressure chamber 423 is at V_{N2}, P₂ (wherein V_{N2}=V_{N1} and P₂=P₁) and buffer fluid chamber 424 is sensibly evacuated. The remainder of the reservoir fluid in flowline 181, that which is not drawn into fluid receptacle 402, passes through main pump 180 and circulates back into the wellbore 105 via flow line 185.

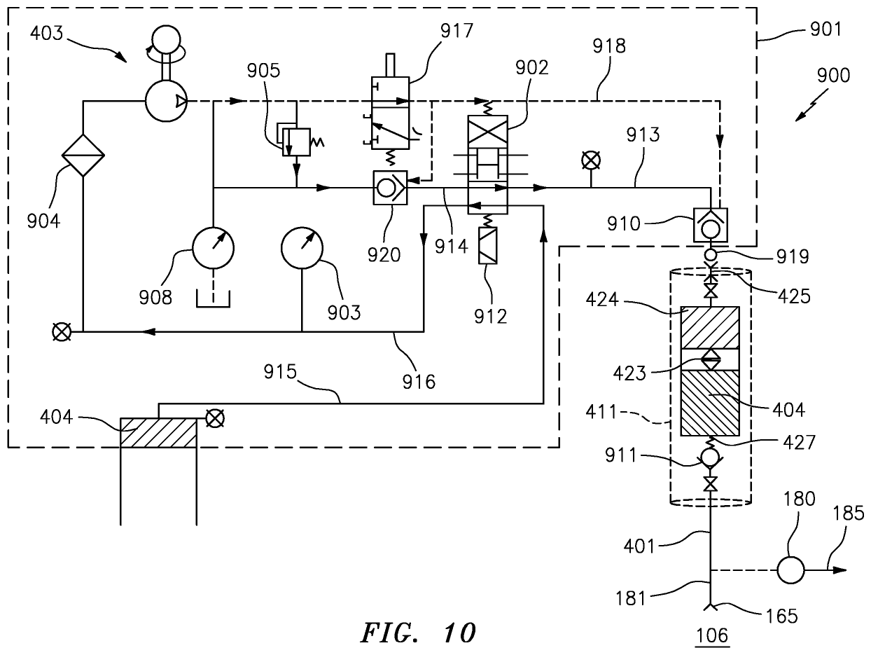

FIG. 10 shows hydraulic circuit 900 during the overcharging, or pressurization, stage of Step 3. During overcharging operations, actuator 912 of buffer fluid control circuit 901 positions servo valve 902 as shown to establish buffer fluid communication between flow line 914 and flow line 913 and to further establish fluid communication between flow line 915 and flow line 916. Isolation valve 917 is energized and secondary pump 403 pumps buffer fluid through flow line 918 to open piloted check valves 910, 919 as shown. Check valve 920 is closed during the overcharge operation. Check valve 911 is closed and no reservoir fluid flows into, or out of, fluid transport line 401 and, if desired, the reservoir fluid in flowline 181 passes through main pump 180 and circulates the fluid back into the wellbore 105 via flow line 185. Secondary pump 403 draws buffer fluid from buffer fluid chamber 404 via flow lines 915, 916 and pumps the fluid into chamber 424 via flow lines 914, 913 through piloted valve 910 and check valve 919 as shown by the directional arrows in the figure. As described herein above with reference to FIG. 6, buffer fluid is added to chamber 424 in a sufficient quantity and pressure to maintain sample chamber 426 at a pressure above the bubble point pressure of the sample. Once the desired overcharge pressure P₃ is achieved, pressure chamber 423 is at V_{N3}, P₃, buffer fluid chamber 424 is at V_{B3}, P₃, and sample chamber 426 is at V_{S3}, P₃, the components of the hydraulic circuit are returned to the states and positions shown in FIG. 8. Another fluid receptacle 402 may be placed between piloted check valve 910 and fluid transport line 401 and another sample may be taken at the same predetermined depth 130 or at another location within the borehole in the same manner described herein above.

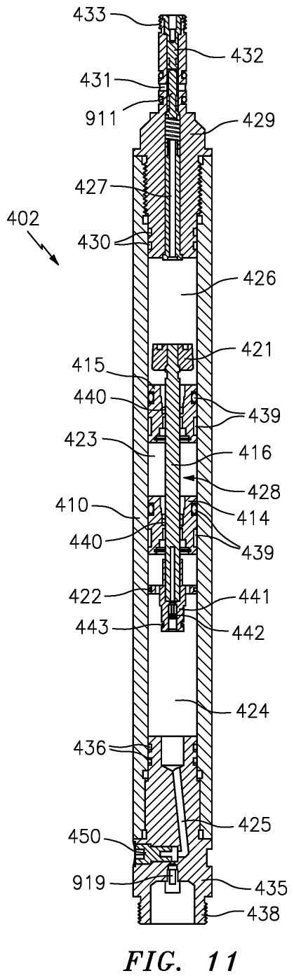

An embodiment of a fluid receptacle 402 in accordance with the present disclosure is best shown with reference to FIG. 11. Port 427 is disposed within sample inlet housing 429 which threaded into housing 410 and further includes seals 430, which can comprise o-rings, to isolate the pressure within chamber 426 described herein above. Spring loaded check valve 911 is disposed within port 427 and works to block sample inlet orifice 431 from fluid communication with fluid transport line 401 (FIG. 2) except during the sample filling operation described herein before with reference to FIG. 9. Also included in sample inlet housing 429 is sample check valve opening jack 432 screwed therein. It should be appreciated that sample check valve opening jack 432 allows for the manual opening of check valve 911 to access any sample fluid within sample chamber 426. Sample inlet housing 429 further includes screw threads 433 at its proximal end to engage with other devices such as a pressure gage (not shown) to interact with sample check valve opening jack 432 to enable a user at the surface to determine the pressure within sample chamber 426.

Still referring to FIG. 11 buffer inlet housing 435 is threadably engaged within housing 410 on an end opposite of sample inlet housing 429 and it further includes seals 436, which can comprise o-rings, to isolate the pressure within buffer fluid chamber 424 described herein above. Buffer inlet housing 435 further includes buffer orifice 425 which is in fluid communication with check valve 919 and also includes screw threads 438 to engage with piloted check valve 910 (FIGS. 8-10). Also included in this particular embodiment of the present disclosure is buffer oil axial force shutoff valve 450 which is used for locking check valve 919 while at the surface.

Still referring to FIG. 11 piston limit bar assembly 428 is shown disposed within housing 410 and includes limit bar 416 having shoulders 421, 422 disposed on either end wherein shoulder 422 is integral with a conduit such as nitrogen fill adapter 441 which will be more fully described herein below. Pistons 414, 415 are also positioned within housing 410 on limit bar 416 between shoulders 421, 422 forming an intermediate pressure chamber 423 therebetween. Pistons 414, 415 further include a set of outer seals 439 and inner seals 440 to both allow the pistons to slide within the housing and along the limit bar and to isolate the pressure within pressure chamber 428 as described herein above. As the pistons 414, 415 are free of valves, nitrogen fill adapter 441 includes nitrogen fill check valve 442 for filling pressure chamber 423 at the surface as will be explained more fully herein below.

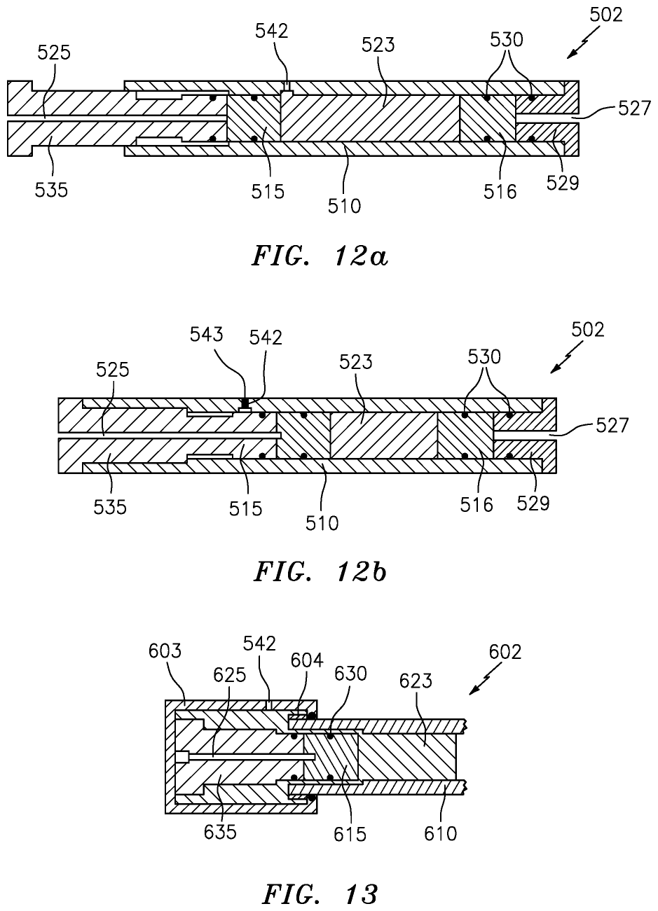

It is an important aspect of the present disclosure that pressure chamber 423 is filled with a sufficient amount of nitrogen at the surface to maintain the sample above its bubble point pressure at all times. In the embodiment of the present disclosure shown in FIG. 11, the initial pressure of the nitrogen P_{N0} may be several thousand psi. It should be appreciated that piston limit bar assembly 428 must be disposed within housing 410 before pressure chamber 423 can be filled with nitrogen. With piston limit bar assembly 428 disposed within housing 410 as shown, and buffer inlet housing 435 removed, a nitrogen source (not shown) is readily attached to screw threads 443 of nitrogen fill adapter 441. The nitrogen is introduced through check valve 442 and through piston 414 into pressure chamber 423 until PNo is reached forcing pistons 414, 415 onto their respective shoulders 422, 421. The nitrogen sourced is then unscrewed and buffer inlet housing 435 is screwed into housing 410. With piston limit bar assembly 428 positioned with shoulder 422 against buffer inlet housing 435, and eliminating any volume there between, a buffer fluid source (not shown) is then threaded onto screw threads 438. With check valve 911 open, buffer fluid is introduced through buffer inlet housing 435 to fill buffer fluid chamber 424 to a pressure P_{B0} at or slightly below P_{N0} as depicted in the initial condition of Step 0 shown in Table 1 and FIG. 3. Buffer oil axial force shutoff valve 450dx ws is then closed to maintain buffer oil chamber 424 at P_{B0}. In the embodiment shown in FIG. 11 it should be noted that the volume of buffer fluid chamber 424 can approximate 0 at certain point of the disclosed method. However, due to the reduction in diameter, and the area thereby, of the end of limit bar 416 in the vicinity of screw threads 443 versus that of the shoulder 422, the pressure needed of the buffer in buffer orifice 425 to over pressure sample chamber 426 could be prohibitively high. Also, in certain embodiments of fluid receptacle 402, a spring can be placed between the shoulder 422 and piston 414 to overcome the friction of outer seals 439 and bias the piston in the direction of piston 415. Another embodiment of a sample receptacle 502 in accordance with the present disclosure is best shown with reference to FIGS. 12a and 12b. In this particular embodiment there is no limit bar connecting pistons 515 and 516 and further there are no openings, holes valves or otherwise, in either of the pistons. This important aspect of the present disclosure greatly simplifies the pistons and eliminates complicated valve arrangements either in the limit bar as described herein above or in the pistons themselves as disclosed in the '664 and '672 patents of the prior art discussed herein above. In the embodiment shown in FIG. 12a sample inlet orifice 527 is disposed within sample inlet housing 529 which is disposed in housing 510. The sample inlet housing 529, pistons 515, 516 and bulkhead 535 include seals 530, which can comprise o-rings, to isolate the pressure within the chambers described herein above with reference to FIG. 11. In the embodiment shown in FIG. 12a, piston 516 is inserted into housing 510 and is positioned against sample inlet housing 529. Piston 515 is partially disposed within housing 510 and bulkhead 535 is partially inserted into housing 510 and axially secured preferably by the engagement of threads (not shown). Pressure chamber 523 is then filled with a suitable pressurization medium, such as N₂, through pressurization port 542 disposed in the wall of housing 510. Pressure chamber 523 is filled to a predetermined pressure and pressurization port 542 is sealed off using a plug 543 (FIG. 12b). For instance, if the total volume between pistons 515, 516 is 900 cc the initial fill pressure of the N₂ can be 2000 psi. At P1=6000 psi, the volume of N₂ will be approximately 300 cc leaving 600 cc for the sample. Once pressure chamber 523 is filled, bulkhead 535 is fully installed within housing 510 as shown in FIG. 12b. Buffer port 525 is filled with a fluid, such as a buffer fluid or wellbore fluid, and controls the flow of sample fluid through sample inlet orifice 527 in a similar manner to the embodiments described herein above.

Referring now to FIG. 13, there is shown an alternative embodiment of the present disclosure for pressuring the pressure chamber 623 of sample receptacle 602. The sample inlet end of this particular embodiment can be the same as that shown in FIGS. 12a, 12b and is not shown in FIG. 13 for the sake of clarity and brevity. Sample receptacle 602 includes a pressurizing fixture 603 removably fixed to the buffer fluid end of housing 610 behind retaining ring 604. Piston 615 is fixed to bulkhead 635 by screw 625 and the buffer bulkhead is fixed to pressurizing fixture 603 by a screw (not shown). With pressurizing fixture 603 positioned on sample receptacle 602 as shown, pressurization chamber 623 is filled with a suitable pressurization medium, such as N₂, through pressurization port 642 disposed in the wall of pressurizing fixture 603 to a predetermined pressure. Once the desired predetermined level of pressure is achieved, pressurizing fixture 603 is translated axially along housing 610 by any known means (not shown) until the threads of bulkhead 635 and housing 610 start to engage. Bulkhead 635 is then screwed into housing 610 by rotating the fixture until o-rings 630 are suitably installed within the housing. Pressurizing fixture 603 can then be removed from the bulkhead and screw 625 can similarly be removed from piston 615 leaving a port in the bulkhead. The buffer port can then be filled with a fluid, such as a buffer fluid or wellbore fluid, and controls the flow of sample fluid through the sample orifice in a similar manner to the embodiments described herein above.

Another embodiment of the present disclosure can be described with reference to FIGS. 2 and 11 wherein fluid receptacle 402 is filled with an enhanced oil recovery (EOR). These EOR fluids are injected from the fluid receptacle(s) 402 into the formation to determine their efficacy in increasing the production of the well 105. An exemplary method of injecting EOR fluid injected from the fluid receptacle(s) 402 is set forth in co-pending patent application PCT/US18/21049, the disclosure of which is included herein in its entirety. In this particular embodiment, pressure chamber 423 of fluid receptacle 402 is pressurized as described herein above to a predetermined pressure. Buffer fluid chamber 424 is then filled with a buffer material through buffer inlet housing 435 and buffer orifice 425 to axially translate piston limit bar assembly 428 such that piston 415 abuts sample inlet housing 429 eliminating most of the “dead volume” in sample chamber 426. A preselected EOR material such as ASP, water, acid, miscible gas, CO₂, disposal fluids, H₂S, mud, polymers, visco-elastic surfactants, acids and fluids containing solid proppants or any other known substances for testing the ability to enhance the recovery of reserves within a formation can then be loaded into sample chamber 426. The EOR material is loaded into sample chamber 426 at the surface via sample inlet orifice 431 and as the sample chamber inlet is filled the piston limit bar assembly 428 is translated axially towards buffer inlet housing 435. Once filled with an EOR substance, the conditions of fluid receptacle 402 resemble that described herein above with reference to FIG. 5 and Step 2. Fluid receptacle 402 can then be loaded into fluid transportation module 400. Once formation testing tool 102 is lowered to its predetermined depth 130, and other operations are performed as necessary, the EOR substance(s) can be injected into formation 106. With valves 303, 405 and 312 appropriately positioned, as well as the previously described check valves, secondary pump 403 is operated to pump fluid from buffer fluid chamber 404 into buffer fluid chamber 424 causing piston limit bar assembly 428 to translate axially towards sample inlet housing 429. In so doing, the EOR substance is pushed out of sample chamber 426 through sample inlet orifice 431 into flowline 181 and out snorkel 165 and into formation 106. The secondary pump 403 is sized to provide a fracking pressure P_{F} to enable the EOR fluid to frac formation 106. It is important to note that once the EOR fluid has been expended from fluid receptacle 402, the fluid receptacle can subsequently be used to store fluids that are withdrawn from formation 106 in the same manner as samples are taken using the methods described herein above. In example embodiments wherein EOR fluids are transported downhole, expelled into the formation, they may be flushed with formation fluid one or more times before being filled with a sample of formation fluid to ensure that a sample representative of the formation is collected.

While the foregoing is directed to only certain embodiments of the present disclosure, certain observations of the breadth of the present disclosure should be made. Wireline, as referred to herein, may be electric wireline including telemetry and power. Wireline may also include wired slickline and wired coil tubing. Embodiments of the present disclosure include pumped-down-the-drill-pipe formation testing where the tools described herein exit through the drill bit. Otherwise heretofore conventional LWD that include the present disclosure allow for formation testing and sampling where the drill pipe may be wired for power and telemetry or some other telemetry such as mud pulse or electromagnetic through the earth. Embodiments of the present disclosure further include probe mounted sampling tools as well as straddle packer types and their use in open hole and cased hole wells. Further, commands and data can be stored using battery power, and power can come from a turbine during circulation. Other and further embodiments of the disclosure may be devised without departing from the basic scope thereof, and the scope thereof is determined by the claims that follow.

1. A tool for carrying a testing fluid comprising:
a housing having at least two pistons slidably disposed therein and dividing the housing into at least three chambers, each of the at least three chambers having a variable volume, including an intermediate chamber, a first end chamber and a second end chamber, the intermediate chamber defined by the pistons and wherein the pistons are free of valves;
a first conduit for pressurizing the intermediate chamber with a gas;
a second conduit adapted to transfer the testing fluid into and out of the first end chamber;
a third conduit adapted to transfer a buffer fluid into and out of the second end chamber; and
a tension member having a length less than an axial length of the housing and wherein the tension member is coupled to the at least two pistons.

2. The tool of claim 1, wherein the transfer of the buffer fluid into the second end chamber reduces the volume of the intermediate chamber.

3. The tool of claim 1, wherein the transfer of the buffer fluid out of the second end chamber causes the transfer of the testing fluid into the first end chamber.

4. The tool of claim 1, wherein the transfer of the buffer fluid into the second end chamber causes the transfer of the testing fluid out of the first end chamber.

5. (canceled)

6. The tool of claim 1, wherein the tension member comprises a limit bar and the at least two pistons are slidably positioned on the limit bar, the limit bar further comprising a shoulder positioned on each end thereof to limit an axial travel of the at least two pistons.

7. The tool of claim 6, wherein the first conduit is disposed within the limit bar.

8. The tool of claim 1, wherein the testing fluid comprises one of a formation fluid and an EOR fluid.

9. The tool of claim 1, further comprising a pump configured to transfer the buffer fluid in and out of the second end chamber and the testing fluid in and out of the second end chamber.

10. A tool for carrying a testing fluid comprising:
a main pump for extracting a formation fluid from a formation and connected to a flow line having an inlet in fluid communication with the formation;
a testing fluid vessel in fluid communication with the flow line positioned between the main pump and the inlet, the testing fluid vessel comprising:
a housing having at least two pistons slidably disposed therein and dividing the housing into at least three chambers, each of the at least three chambers having a variable volume, including an intermediate chamber, a first end chamber and a second end chamber, the intermediate chamber defined by the pistons and wherein the pistons are free of valves;
a first conduit for pressurizing the intermediate chamber with a gas;
a second conduit adapted to transfer the testing fluid into and out of the first end chamber; and
a third conduit adapted to transfer a buffer fluid into and out of the second end chamber;
the third conduit selectively exposed to a well bore pressure; and
a secondary pump connected to the third conduit to selectively transfer the buffer fluid into and out of the second end chamber.

11. (canceled)

12. The tool of claim 10, wherein the transfer of the buffer fluid into the second end chamber reduces the volume of the intermediate chamber.

13. The tool of claim 10, wherein the transfer of the buffer fluid out of the second end chamber causes the transfer of the testing fluid into the first end chamber.

14. The tool of claim 10, wherein the transfer of the buffer fluid into the second end chamber causes the transfer of the testing fluid out of the first end chamber.

15. The tool of claim 10, including a tension member having a length less than an axial length of the housing and wherein the tension member is coupled to the at least two pistons.

16. The tool of claim 15, wherein the tension member comprises a limit bar and the at least two pistons are slidably positioned on the limit bar, the limit bar further comprising a shoulder positioned on each end thereof to limit an axial travel of the at least two pistons.

17. The tool of claim 16, wherein the first conduit is disposed within the limit bar.

18. The tool of claim 10, wherein the testing fluid comprises one of the formation fluid and an EOR fluid.

19. The tool of claim 18, wherein the secondary pump transfers the buffer fluid out of the second end chamber causing the formation fluid to transfer into the second end chamber without going through the main pump.

20. The tool of claim 19, wherein the secondary pump transfers the buffer fluid into the second end chamber and reduces the volume of the intermediate chamber and thereby over pressurizes the formation fluid in the second end chamber.

21. The tool of claim 18, wherein the secondary pump transfers the buffer fluid into the second end chamber causing the EOR fluid to transfer out of the second end chamber, out of the inlet, and into the formation without going through the main pump.

22. The tool of claim 20, further comprising a pressure gauge coupled to the first end chamber indicating a pressure of the formation fluid in the first end chamber.

23. A method of carrying a testing fluid comprising:
providing a housing;
disposing at least two pistons slidably within the housing and dividing the housing into at least three chambers, each of the at least three chambers having a variable volume, including an intermediate chamber, a first end chamber and a second end chamber;
providing a limit bar wherein the at least two pistons are slidably positioned on the limit bar, the limit bar further comprising a shoulder positioned on each end thereof and thereby defining a maximum axial travel of the at least two pistons
positioning the at least two pistons at the maximum axial travel;
pressurizing the intermediate chamber with a gas;
transferring the testing fluid into and out of the first end chamber; and
transferring a buffer fluid into and out of the second end chamber.

24. The method of claim 23, wherein the transferring of the buffer fluid into the second end chamber reduces the volume of the intermediate chamber and wherein the transferring of the buffer fluid out of the second end chamber causes the transferring of the testing fluid into the first end chamber.

25. The method of claim 23, wherein the transferring of the buffer fluid into the second end chamber causes the transferring of the testing fluid out of the first end chamber.

26. (canceled)

27. (canceled)

28. The method of claim 23, wherein the pressurizing through a conduit is disposed within the limit bar.

29. The method of claim 23, wherein the testing fluid comprises one of a formation fluid and an EOR fluid.

30. The method of claim 29, further comprising:
pressurizing of the intermediate chamber providing a gas pressure P_{N0} and a gas volume of V_{N0}, the first end chamber has a buffer fluid volume of V_{B0} and a second end chamber volume of substantially zero;
positioning the housing within a tool at a predetermined depth within a wellbore and in fluid communication with a formation having a pressure P_{R} and the formation containing the formation fluid;
prefilling the second end chamber with the formation fluid wherein the buffer fluid volume is V_{B1}, the gas volume is V_{N1}, and the second end chamber volume is substantially zero and wherein the first end chamber, the intermediate chamber and the second end chamber have a pressure of P₁,
filling the second end chamber with the formation fluid wherein the buffer fluid volume is substantially zero, the gas volume is V_{N2}, and the second end chamber has a formation fluid volume of V_{S2} and wherein the pressure of the first end chamber, the intermediate chamber and the second end chamber is P₂,
over pressurizing the formation fluid to an over pressure of P₃ and wherein the gas volume is V_{N3}, the buffer fluid volume is V_{B3} and the formation fluid volume is V_{S3}; and
transporting the tool to a surface position wherein the gas volume is V_{N4}, the buffer fluid volume is V_{B4} and the formation fluid volume is V_{S4} and wherein the pressure of the first end chamber, the intermediate chamber and the second end chamber is P₄.

31. The method of claim 30, wherein P₁ is equal to P_{R} minus a drawdown pressure and P₄ is above a bubble point pressure of the formation fluid.

32. The method of claim 29, further comprising:
pressurizing of the intermediate chamber providing a gas pressure of P_{N0} and a gas volume of V_{N0}, the first end chamber has a buffer fluid volume of V_{B0} and a second end chamber volume of substantially zero;
filling the second end chamber with the EOR fluid wherein the buffer fluid volume is substantially zero, the gas volume is V_{N0}, and the second end chamber has an EOR fluid volume of V_{S0} and wherein the gas pressure is P_{N0} and having a buffer fluid pressure that is substantially zero and having an EOR fluid pressure that is substantially zero,
positioning the housing within a tool at a predetermined depth within a wellbore and in fluid communication with a formation having a pressure P_{R} and the formation containing the formation fluid;
filling the first end chamber with the buffer fluid to a pressure above P_{F}; and
expelling the EOR fluid into the formation.

33. The method of claim 32, wherein P_{F} is greater than P_{R} and wherein the EOR fluid fractures the formation.
